(19) United States
(12) Patent Application Publication
(10) Pub. No.: US 2016/0246551 A1
(43) Pub. Date: Aug. 25, 2016

(54) Server, Client Terminal, Print System and Non-Transitory Computer-Readable Recording Medium

(71) Applicant: Konica Minolta, Inc., Tokyo (JP)

(72) Inventors: Chie Ichikawa, Tokyo (JP); Yoshiyuki Harada, Tokyo (JP)

(73) Assignee: Konica Minolta, Inc., Tokyo (JP)

(21) Appl. No.: 15/050,546

(22) Filed: Feb. 23, 2016

(30) Foreign Application Priority Data
Feb. 24, 2015 (JP) 2015-034583

(51) Int. Cl. G06F 3/12; G06F 9/445

(52) U.S. Cl. CPC G06F 3/1222; G06F 3/1225; G06F 3/1238; G06F 3/1289; G06F 8/60

(57) ABSTRACT

Disclosed is a server including: a restriction information registering unit configured to fetch restriction information relating to a setting of a print condition for each user and to register the restriction information in the printer driver data area; and a distribution unit configured to download the printer driver program and the restriction information to a client terminal, wherein in case that the printer driver program is executed by the client terminal, the printer driver program causes the client terminal to have a print condition setting function for obtaining the restriction information for the user who currently uses the client terminal from the printer driver data area of the client terminal, preparing a print setting window in which the print condition is restricted in accordance with the obtained restriction information and displaying the print setting window on a display unit of the client terminal.

### CROSS-REFERENCE TO RELATED APPLICATIONS

The present U.S. patent application claims priority to Japanese Patent Application No. 2015-034583, filed on Feb. 24, 2015, according to the Paris Convention. The entirety of Japanese Patent Application No. 2015-034583 is incorporated herein by reference.

### BACKGROUND OF THE INVENTION

1. Field of the Invention

The present invention relates to a non-transitory computer-readable recording medium which stores a printer driver program used by downloading it from a server to a client terminal; a print system for distributing the printer driver program from a server to a client terminal; a server; a non-transitory computer-readable recording medium which stores a server program; a client terminal; and a non-transitory computer-readable recording medium which stores a client program.

2. Description of Related Art

Recently, a printer is usually shared by a plurality of users via a network. In this case, it is necessary to install a printer driver in a PC of each user. Conventionally, a printer driver has been installed from a recording medium, such as a CD-ROM or the like. On the other hand, in recent years, a printer driver is distributed from a server to client terminals via a network by the Point and Print (PnP) provided by Window®.

In the Point and Print, the printer driver of the common printer is previously registered in the server. When the client terminal designates the common printer as the print destination, the printer driver of the designated common printer is automatically downloaded from the server to the client terminal and is installed.

By using the system of the Point and Print, an IT administrator can effectively and easily provide an optional printer driver for each user and can easily manage the update of the print driver, and the like.

In the above system, it is desirable that the print function which can be selected by the client terminal (the print condition which can be set) can be collectively restricted by the server. For example, Japanese Patent Application Publication No. 2010-039926 discloses the print system in which the server can collectively restrict the print function which can be selected by each client terminal, without using a dedicated application program. In this technology, in case that the printer driver is shared by a plurality of client terminals in the Point and Print, the printer driver itself judges whether the printer driver is currently installed in the client terminal or in the server. In case that it is judged that the printer driver is installed in the client server, the print setting window in which the functions are previously restricted by the administrator is displayed.

In case that the printer is shared, it is requested to restrict the functions for each section or each user.

However, in case that the Point and Print is carried out in the system compliant with the Windows® operating system, the print setting which is set by using the printer driver on the server is directly set to the client terminal. As a result, the function restriction which is different for each client terminal cannot be carried out.

By using the technology disclosed in Japanese Patent Application Publication No. 2010-039926, it is possible to carry out the function restriction which is different according to the case in which the print setting is carried out in the server or the case in which the print setting is carried out in the client terminal. However, because the function restriction is uniformly carried out for all of the client terminals, it is not possible to carryout the function restriction which is different for each client terminal.

On the other hand, when a nonstandard special system is constructed in order to carry out the function restriction which is different for each client terminal, a large task for the construction and the management thereof is required.

### SUMMARY

To achieve at least one of the abovementioned objects, a server reflecting one aspect of the present invention, comprises:

a first storing unit in which a printer driver program is stored;

a second storing unit in which a printer driver data area is provided;

a restriction information registering unit configured to fetch restriction information relating to a setting of a print condition for each user and to register the restriction information in the printer driver data area; and

a distribution unit configured to download the printer driver program and the restriction information registered in the printer driver data area to a client terminal, and to register the restriction information in a printer driver data area of the client terminal,

wherein in case that the printer driver program is executed by the client terminal, the printer driver program causes the client terminal to have a print condition setting function for obtaining identification information of a user who currently uses the client terminal, obtaining the restriction information for the user from the printer driver data area of the client terminal, preparing a print setting window in which the print condition which can be set is restricted in accordance with the obtained restriction information and displaying the print setting window on a display unit of the client terminal.

Preferably, the distribution unit downloads the printer driver program and the restriction information to the client terminal by using a Point and Print.

### BRIEF DESCRIPTION OF THE DRAWINGS

The present invention will become more fully understood from the detailed description given hereinafter and the accompanying drawings given byway of illustration only, and thus are not intended as a definition of the limits of the present invention, and wherein:

FIG. 1 is a view showing a configuration example of the print system according to the embodiment;

FIG. 2 is a view showing the schematic configuration of the server;

FIG. 3 is a view showing the schematic configuration of the client terminal;

FIG. 4 is a view showing an example of the structure of the restriction information;

FIG. 5 is a view showing the software configuration in the server;

FIG. 6 is a view showing the software configuration in the client terminal;

FIG. 7 is a view showing the print setting window in case that the function restriction is not set;

FIG. 8 is a view showing the print setting window in case that the function restriction is set;

FIG. 9 is a flowchart showing the process which is carried out by the printer driver program in the server;

FIG. 10 is a flowchart showing the process which is carried out by the printer driver program in the client terminal; and

FIG. 11 is a view showing an example of the warning which is displayed in a pop-up window in case that the contents of the function restriction are changed.

### DETAILED DESCRIPTION OF PREFERRED EMBODIMENT

Hereinafter, a preferred embodiment of the present invention will be explained with reference to the accompanying drawings.

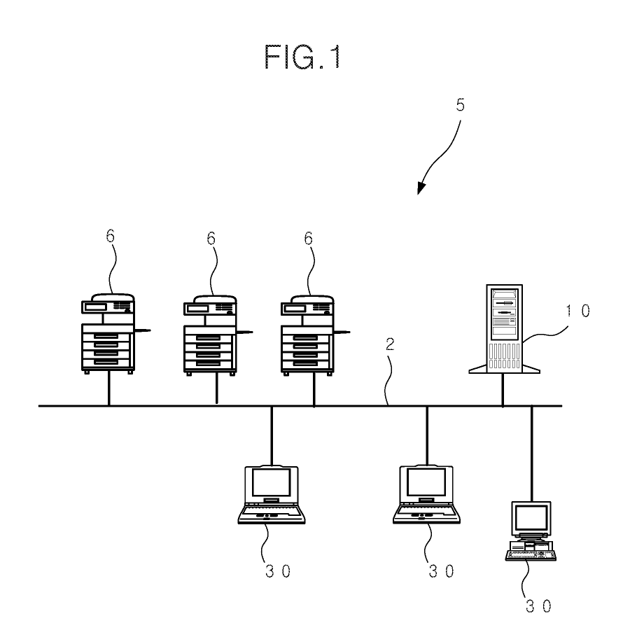

FIG. 1 shows an example of the print system 5 according to the embodiment. The print system 5 is configured by connecting a server 10, client terminals 30 and print apparatuses 6 via a network 2, such as LAN (Local Area Network). The server 10 is a computer device. The client terminal 30 is a personal computer or the like.

The print apparatus 6 is an apparatus for receiving a print job transmitted from the client terminal 30 via the network 2, and for printing out a document or an image on the recording sheet in accordance with the contents of the print job. The print apparatus 6 is used as the shared printer.

The printer driver program installed in the server 10 is downloaded to each client terminal 30 by using the system of the Point and Print, and is shared by each user.

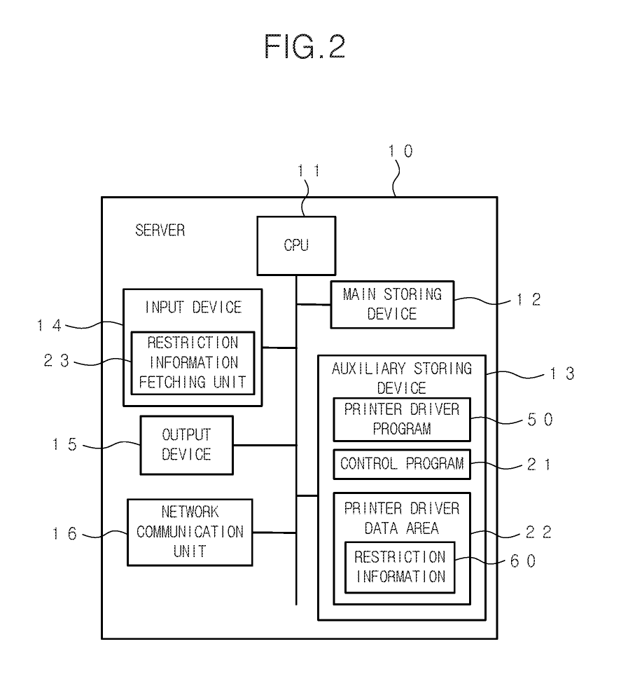

FIG. 2 is a block diagram showing the schematic configuration of the server 10. The server 10 is configured by connecting the CPU (Central Processing Unit) 11 for entirely controlling the operation of the server 10 with a main storing device 12, an auxiliary storing device 13, an input device 14, an output device 15, a network communication unit 16 and the like.

By the CPU 11, a middleware, application programs and the like are executed on an OS (Operating System) program as a base.

The main storing device 12 is a memory for temporarily storing the information which is necessary when the CPU 11 carries out the process. The auxiliary storing device 13 is a memory device which functions as the auxiliary memory of the main storing device 12, and is a large-capacity nonvolatile storing device, such as a hard disk drive. In the auxiliary storing device 13, various types of programs, such as the above-described OS program, the middleware, the application programs and the like (which are correctively referred to as the control program 21), are stored in addition to the printer driver program 50. Further, in the auxiliary storing device 13, the printer driver data area 22 is provided. In the printer driver data area 22, the restriction information 60 is registered. The restriction information 60 indicates the restriction relating to the setting of the print condition for each user.

The printer driver data area 22 is a storing area which can be shared with the client terminals 30 via the system of the Point and Print provided by the Windows® operating system, and includes the storing area in the HKAY_LOCAL_MACHINE area of the registry, Queue Property Bag of the v4 Driver, and the like. The restriction information 60 is stored in the printer driver data area 22.

The input device 14 comprises a device for receiving the input operation from a user, such as a keyboard, a mouse or the like, and an input interface for inputting a command, information, data, a file and the like from an external device. The input device 14 (or the network communication unit 16) has the function as the restriction information fetching unit 23 for fetching the restriction information 60 to be registered in the printer driver data area 22 from an external device.

The output device 15 comprises a display unit, such as a display or the like, and is a device for outputting the information indicating the result of the process carried out by the CPU 11, to an external device.

The network communication unit 16 has the function for communicating with each client terminal 30 and another external device via the network 2.

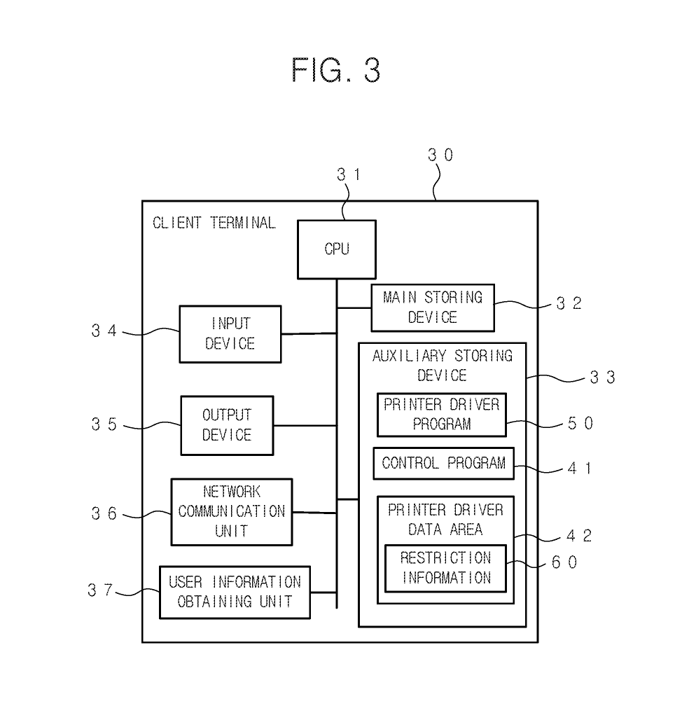

FIG. 3 is a block diagram showing the schematic configuration of the client terminal 30. The client terminal 30 is configured by connecting the CPU 31 for entirely controlling the operation of the client terminal 30 with a main storing device 32, an auxiliary strong device 33, an input device 34, an output device 35, a network communication unit 36, a user information obtaining unit 37 and the like.

By the CPU 31, a middleware, application programs and the like are executed on an OS (Operating System) program as a base.

The main storing device 32 is a memory for temporarily storing the information which is necessary when the CPU 31 carries out the process. The auxiliary storing device 33 is a memory device which functions as the auxiliary memory of the main storing device 32, and is a large-capacity nonvolatile storing device, such as a hard disk drive. In the auxiliary storing device 33, various types of programs, such as the above-described OS program, the middleware, the application programs and the like (which are correctively referred to as the control program 41), are stored in addition to the printer driver program 50 which is downloaded from the server 10 by using the Point and Print. Further, in the auxiliary storing device 33, the printer driver data area 42 is provided. In the printer driver data area 42, the restriction information 60 downloaded from the server 10 by using the Point and Print is stored. The printer driver data area 42 is a similar area to the printer driver data area 22 of the server 10. The control program 41 functions as the storing control unit for storing the received printer driver program 50 in the storing unit and for registering the received restriction information 60 in the printer driver data area 42.

The input device 34 comprises a device for receiving the input operation from a user, such as a keyboard, a mouse or the like, and an input interface for inputting a command, information, data, a file and the like from an external device. The output device 35 comprises a display unit, such as a display or the like, and is a device for outputting the information indicating the result of the process carried out by the CPU 31, to an external device.

The network communication unit 36 has the function for communicating with the server 10, each print apparatus 6 and another external device via the network 2. The network communication unit 36 functions as the transmission unit for transmitting the download request to the server 10, and as the reception unit for receiving the restriction information 60 and the printer driver program 50 from the server 10.

The user information obtaining unit 37 has the function for obtaining the information (identification information) of the user who currently uses the client terminal 30. The user information obtaining unit 37 is an input device for inputting the authentication information for authenticating a user, for example, an IC card reading device, a vein authentication information reading device or the like. In case that a user is authenticated by inputting a user ID and a password via a keyboard, the input device 34 has also the function as the user information obtaining unit 37.

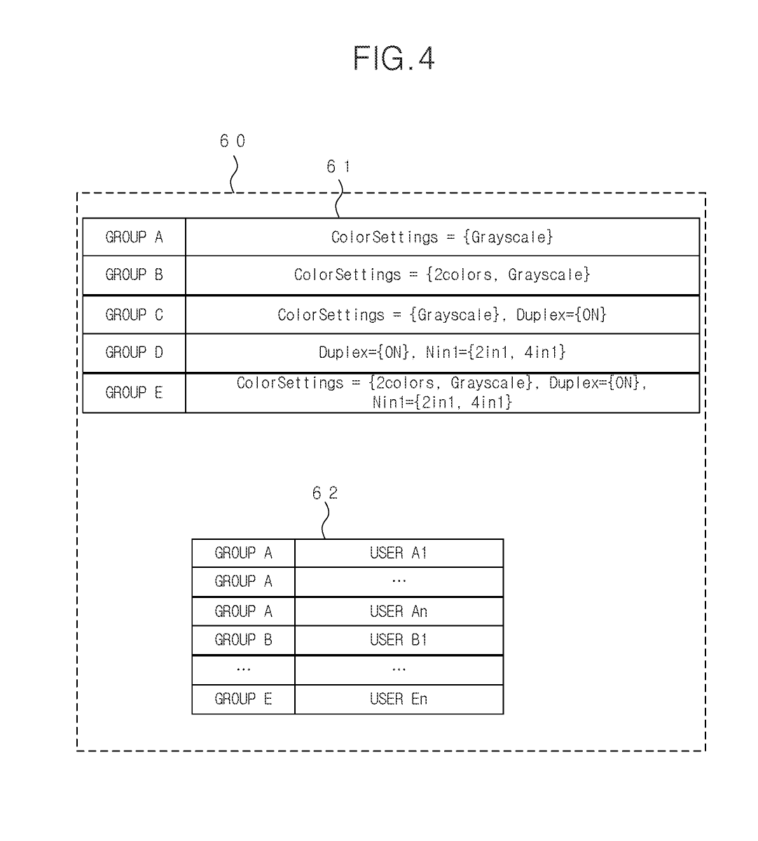

FIG. 4 shows an example of the restriction information 60. The restriction information 60 is information indicating the restriction relating to the setting of the print condition for each user. In an example shown in FIG. 4, the restriction information 60 comprises the first table 61 and the second table 62. The first table 61 indicates the restriction information relating to the setting of the print condition for each group. The second table 62 indicates the users who belong to each group.

According to the first table 61 shown in FIG. 4, the group A is admitted to use only the “grayscale” of the “color settings”. The group B is admitted to use the “grayscale” and the “2 colors” of the “color settings”. The group C is admitted to use only the “grayscale” of the “color settings” and to use the “duplex”. The group D is admitted to use the “duplex”, and to use the “2in1” and the “4in1” in the Nin1 function for arranging N pages in one page by reducing the N pages. The group E is admitted to use the “grayscale” and the “2 colors” of the “color settings” and to use the “duplex”, the “2in1” and the “4in1”.

For example, it is recognized that the user A1 belongs to the group A from the second table 62, and that the group A is admitted to use only the “grayscale” of the “color settings” from the first table 61. Therefore, the restriction information for the user A1 indicates that the user A1 is admitted to use only the “grayscale” of the “color settings”.

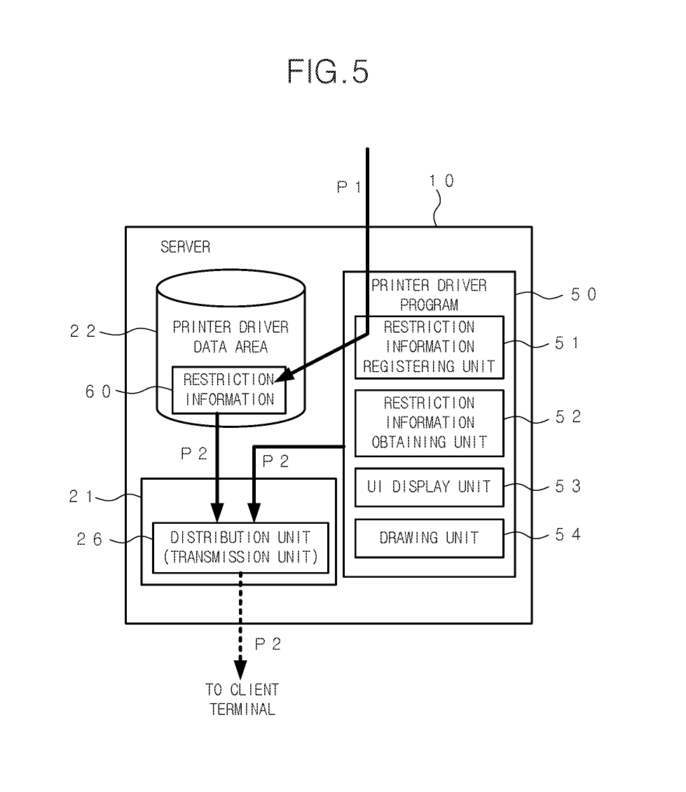

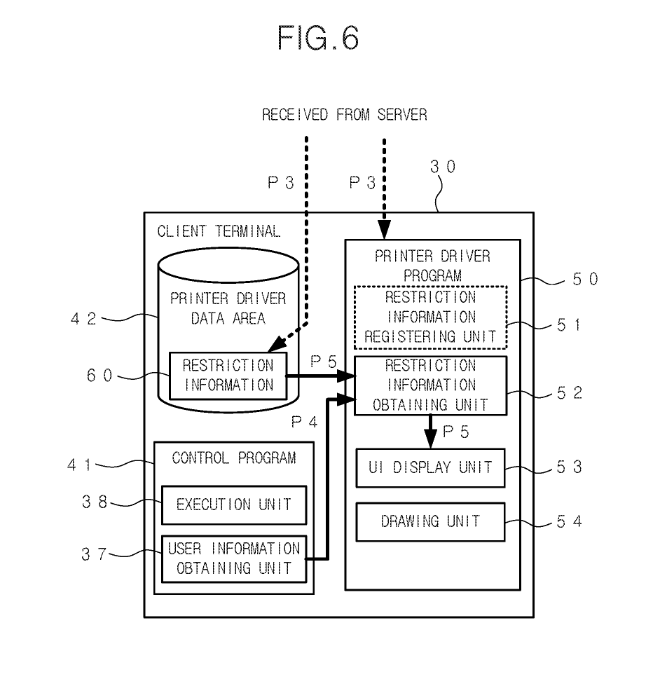

FIG. 5 shows the basic software configuration in the server 10, and FIG. 6 shows the basic software configuration in the client terminal 30.

The printer driver program 50 to be executed by the client terminal 30 is downloaded from the server 10 by using the Point and Print or the like, and is the same as the printer driver program installed in the server 10. Further, the restriction information 60 stored in the printer driver data area 42 of the client terminal 30 is downloaded from the server 10 by using the Pint and Print or the like, and is the same as the restriction information 60 registered in the printer driver data area 22 of the server 10.

The printer driver program 50 has each function of the restriction information registering unit 51, the restriction information obtaining unit 52, the UI display unit 53 and the drawing unit 54.

The restriction information registering unit 51 has the function for fetching the restriction information 60 from an external device via the restriction information fetching unit 23, and for registering the fetched restriction information 60 in the printer driver data area 22. In case that the printer driver program 50 is executed by the server 10, the restriction information registering unit 51 is active. On the other hand, in the client terminal 30 which is the download destination, the restriction information registering unit 51 is inactive.

In case that the printer driver program 50 is executed by the client terminal 30 which is the download destination of the printer driver program 50, the restriction information obtaining unit 52 fetches the restriction information 60 from the printer driver data area 42 of the client terminal 30, and extracts the restriction information for the user who currently uses the client terminal 30 from the fetched restriction information 60 to transmit the extracted restriction information to the UI display unit 53.

The UI display unit 53 prepares the print setting window in which the print condition which can be set is restricted in accordance with the restriction information transmitted from the restriction information obtaining unit 52. Then, the UI display unit 53 displays the prepared print setting window on the output device 35 (display) of the client terminal 30, and receives various types of settings relating to the print condition from the user. The function of the function restriction unit is realized by the restriction information obtaining unit 52 and the UI display unit 53.

The drawing unit 54 prepares the print data from the document designated by the application program in accordance with the print condition set via the print setting window. Then, the drawing unit 54 instructs the print apparatus 6 to print an image by transmitting the prepared print data to the print apparatus 6.

On the server 10 side, the restriction information registering unit 51 of the printer driver program 50 reads the file or the like, in which the restriction information for each user is described, and registers the restriction information in the printer driver data area 22 (P1 in FIG. 5).

Then, when the request to download the printer driver is received from the client terminal 30, the distribution unit (or transmission unit) 26 of the control program 21 transmits the printer driver program 50 and the restriction information 60 registered in the printer driver data area 22 to the client terminal 30 which transmits the above request, by using the system of the Point and Print or the like (P2 in FIG. 5).

The client terminal 30 receives the printer driver program 50 transmitted from the server 10 and installs the program 50 therein. Further, the client terminal 30 registers the restriction information 60 transmitted from the server 10 in the printer driver data area 42 (P3 in FIG. 6).

The execution unit 38 included in the control program 41 of the client terminal 30 executes the printer driver program 50 in case that the execution of the printer driver program is request by the user. Further, the execution unit 38 transmits the print data prepared by the printer driver program 50 to the print apparatus 6 designated by the user.

When the printer driver program 50 is executed, the restriction information registering unit 51 is inactive. That is, in the client terminal 30, the restriction information 60 is prohibited from being rewritten.

In the client terminal 30, when the printer driver program 50 is started up, the restriction information obtaining unit 52 obtains the information relating to the user who currently uses the client terminal 30, for example, login ID of the Windows® operating system, SSO (Single Sign-On) information or the like (P4). Then, the restriction information obtaining unit 52 extracts the restriction information for the user who currently uses the client terminal 30 from the restriction information 60 registered in the printer driver data area 42, and transmits the extracted restriction information to the UI display unit 53 (P5).

The UI display unit 53 prepares the print setting window in which the print condition which can be set is restricted in accordance with the restriction information transmitted from the restriction information obtaining unit 52, and further displays the prepared print setting window on the output device 35 (display) of the client terminal 30. Then, the client terminal 30 receives various types of settings relating to the print condition from the user.

When the instruction for printing an image is received from the user after the setting of the print condition is finished, the drawing unit 54 prepares the print data from the document designated by the application program in accordance with the print condition set via the print setting window. The prepared print data is transmitted to the print apparatus 6.

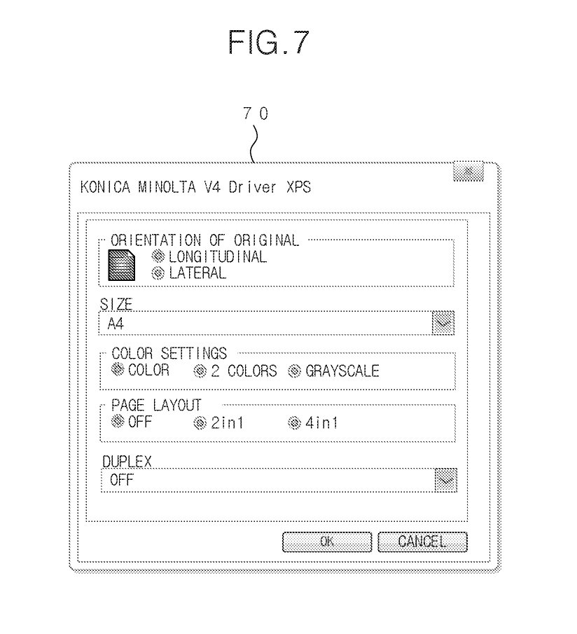

FIG. 7 shows an example of the print setting window 70 in case that the restriction relating to the setting of the print condition is not carried out. In the print setting window 70, with respect to the color settings, the options “color”, “2 colors” and “grayscale” are provided. The user can select one among the above options. With respect to the page layout, the options “off”, “2in1” and “4in1” are provided. The user can select one among the above options. With respect to the duplex, the user can select “off” or “on”.

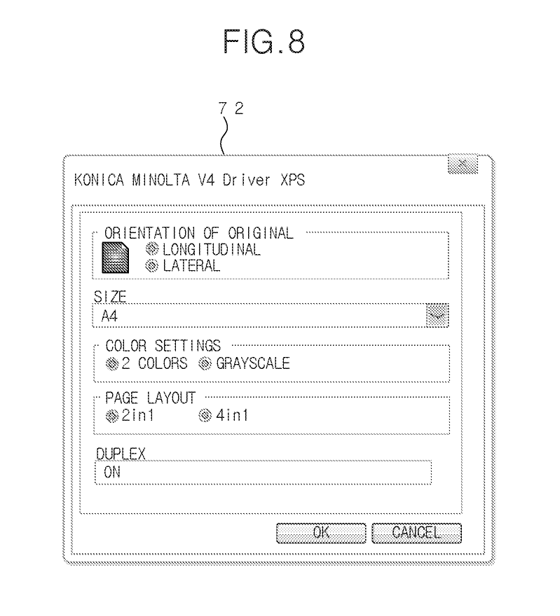

FIG. 8 shows an example of the print setting window 72 in which the print condition which can be set is restricted in accordance with the restriction information for the user who belongs to the group E in the restriction information 60 shown in FIG. 4. In the print setting window 72, with respect to the color settings, the options “2 colors” and “grayscale” are provided, and the option “color” is restricted so as not to be selected. With respect to the page layout, the options “2in1” and “4in1” are provided, and the option “off” is restricted so as not be selected. With respect to the duplex, the user can select only the option “on” and the option “off” is restricted so as not be selected.

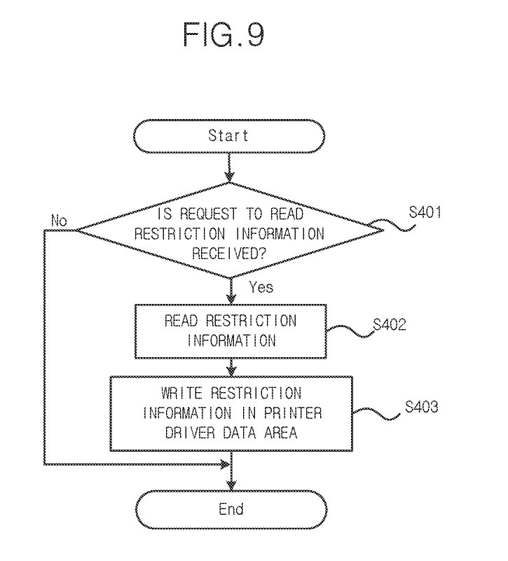

In FIG. 9, the flow of the process executed by the printer driver program 50 in the server 10 will be explained. Firstly, it is confirmed whether the request to read the restriction information is received (Step S401). Specifically, for example, in case that the request to obtain the CSV file in which the restriction information is described is received from the device property window of the printer driver, it is determined that the request to read the restriction information is received.

In case that the request to read the restriction information is received (Step S401; Yes), restriction information registering unit 51 of the printer driver reads the restriction information 60, for example, from the CSV file or the like (Step S402), and writes and stores the above restriction information 60 in the printer driver data area 22 (Step S403).

When the printer driver program 50 stored in the server 10 is downloaded to the client terminal 30 and is installed in the client terminal 30 by using the system of the Point and Print or the like, the restriction information 60 stored in the printer driver data area 22 in Step S403 is also downloaded with the printer driver program 50 and is shared with the client terminal 30.

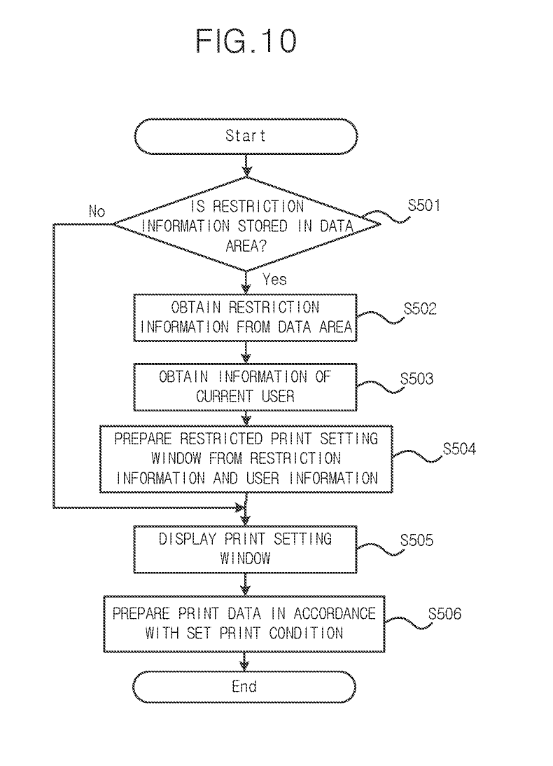

Next, in FIG. 10, the flow of the process executed in the client terminal 30, that is, the flow of the process executed by the printer driver program 50 which is shared by the server 10 with the client terminal 30 will be explained. When the request to start up the printer driver is received, the restriction information obtaining unit 52 of the printer driver program 50 confirms whether the restriction information 60 is stored in the printer driver data area 42 (Step S501).

In case that the restriction information 60 is stored in the printer driver data area 42, the restriction information obtaining unit 52 obtains the restriction information 60 from the printer driver data area 42 (Step S502). Next, the restriction information obtaining unit 52 obtains the information relating to the current user, for example, the login ID of the Windows® operating system, the SSO information or the like (Step S503). The UI display unit 53 prepares the print setting window in which the function restriction suitable for the current user is carried out in accordance with the restriction information 60 and the information relating to the current user, which is obtained by the restriction information obtaining unit (Step S504). Then, the prepared print setting window is displayed on the display unit of the client terminal 30 to receive the setting operation for setting the print condition from the user (Step S505).

Then, when the request to execute the printing is received, the drawing unit 54 prepares the print data from the document designated by the application program in accordance with the print condition set in Step S505 (Step S506). The print data is transmitted to the designated print apparatus 6.

The restriction information 60 stored in the printer driver data area 22 of the server 10 is downloaded to the client terminal 30 every when the download request is received from the client terminal 30. Therefore, incase that an administrator or the like wants to update the contents of the restriction information, by updating the restriction information 60 in the server 10, the updated restriction information 60 is shared with the client terminal 30 at the next download.

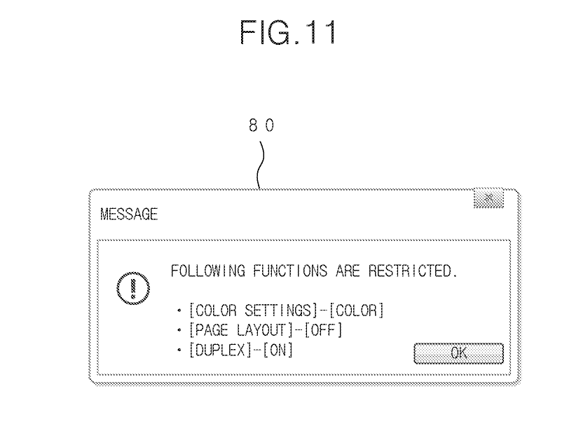

In this case, the contents of the restriction information downloaded at the last time are compared with the contents of the restriction information to be downloaded at this time, and when the restriction information downloaded at the last time is different from the restriction information to be downloaded at this time, as shown in FIG. 11, by notifying the user of the changed contents of the restriction information in a pop-up window 80 or the like, the user's attention may be attracted.

For example, when the restriction information 60 is updated, the server 10 writes the change information indicating the difference of the restriction information, in the printer driver data area 22. Then, when the restriction information 60 is downloaded to the client terminal 30 at the next time, the change information is simultaneously downloaded to the client terminal 30. The printer driver program 50 stored in the client terminal 30 displays the pop-up window 80 shown in FIG. 11 in accordance with the downloaded change information, for example, when the print setting window is displayed by starting up the printer driver.

As described above, in the print system 5, by registering the restriction information 60 for each user in the printer driver data area 22 of the server 10, when the printer driver program 50 is executed in the client terminal 30, it is possible to additionally restrict the setting of the print condition according to the user who currently uses the client terminal 30.

In particular, because the restriction information 60 is registered in the printer driver data area 22, that is, in the storing area in HKAY_LOCAL_MACHINE area of the registry, Queue Property Bag of the v4 Driver, and the like, it is possible to download the restriction information 60 from the server 10 to the client terminal 30 and to share the restriction information 60 with the client terminal 30 by using the system of the Point and Print compliant with the Windows® operating system. Therefore, in case that the printer driver program is executed by the client terminal 30, the different function restriction to be carried out according to each user can be controlled by the server 10 without preparing a special tool. As described above, in the embodiment, by using the function compliant with the Windows® operating system, it is possible to carry out the function restriction for each user by the server.

As described above, the embodiment is explained by using the drawings. However, in the present invention, the concrete configuration is not limited to the above embodiment. In the present invention, various modifications of the above embodiment or the addition of various functions or the like to the embodiment can be carried out without departing from the gist of the invention.

In the embodiment, the printer driver program 50 has the function of the restriction information registering unit 51. However, the function of the restriction information registering unit 51 may be provided in another program which is stored in the server 10 and which is different from the printer driver program 50. All functions of the printer driver program 50 are executed also in the server 10. The server 10 is used for sharing the printer driver program 50 and it is not necessary that the server 10 has the function for distributing the print data received from the client terminal 30 or the like to the print apparatus 6.

In this embodiment, the printer driver program 50 and the restriction information 60 are downloaded to the client server 30 by the system of the Point and Print to share the printer driver program 50 and the like. However, by another program, the printer driver program 50 and the like may be downloaded.

The present invention may be applied to the server 10 or the client terminal 30 in the print system 5 in addition to the print system 5. Further, the present invention may be applied to the printer driver program 50, the program for operating the server 10 or the program for operating the client terminal 30.

One of the objects of the above embodiment is to provide a print system, a server, a client terminal and a non-transitory computer-readable recording medium which can carry out the function restriction which is different for each user without using a special tool in the printer driver provided from the server to the client terminal.

In this embodiment, the restriction information relating to the setting of the print condition for each user is registered in the printer driver data area of the server. The restriction information and the printer driver program are downloaded from the server to the client terminal by using the Point and Print or the like. When the printer driver program is executed in the client terminal, the restriction information for the user who currently uses the client terminal is obtained among the restriction information which is downloaded from the server and which is registered in the printer driver data area of the client terminal. Then, the print setting window in which the function is restricted in accordance with the restriction information is displayed and the setting operation for setting the print condition is received. Therefore, by registering the restriction information relating to the setting of the print condition for each user in the printer driver data area of the server, it is possible to carry out the function restriction according to the user who uses the client terminal when the setting of the print condition is received by the client terminal.

In this embodiment, the printer driver program which is executed in the server has the restriction information registering function.

In this embodiment, the restriction information is prohibited from being rewritten in the client terminal.

In this embodiment, the printer driver program and the restriction information are downloaded from the server to the client terminal by using the Point and Print compliant with the Windows® operating system.

In this embodiment, in case that the printer driver program is executed by the client terminal, the printer driver program obtains the restriction information for the user who currently uses the client terminal from the printer driver data area of the client terminal, and displays the print setting window in which the function restriction is carried out in accordance with the restriction information for the current user.

In this embodiment, in case that the printer driver program is executed by the server, the printer driver program causes the server to have the function for fetching the restriction information relating to the setting of the print condition for each user and registering the fetched restriction information in the printer driver data area.

In this embodiment, by executing the printer driver program downloaded from the server, the client terminal displays the print setting window in which the function is restricted in accordance with the restriction information for the user who currently uses the client terminal among the restriction information downloaded from the server, and receives the setting operation for setting the print condition.

In this embodiment, the server of the print system obtains the restriction information relating to the setting of the print condition for each user and registers the restriction information in the printer driver data area. The restriction information and the printer driver program are downloaded from the server to the client terminal by using the Point and Print or the like. When the client terminal executes the downloaded printer driver program, the client terminal obtains the restriction information for the user who currently uses the client terminal among the restriction information which is downloaded from the server and which is registered in the printer driver data area of the client terminal. Then, the client terminal displays the print setting window in which the function is restricted in accordance with the restriction information, and receives the setting operation for setting the print condition. Therefore, by registering the restriction information relating to the setting of the print condition for each user in the printer driver data area of the server, it is possible to carry out the function restriction according to the user who uses the client terminal when the setting of the print condition is received by the client terminal.

In the embodiment, the printer driver program which is executed in the server has the restriction information registering function.

In the embodiment, the server of the print system obtains the restriction information relating to the setting of the print condition for each user and registers the restriction information in the printer driver data area. The restriction information and the printer driver program are downloaded from the server to the client terminal by using the Point and Print or the like. When the client terminal executes the downloaded printer driver program, the client terminal obtains the restriction information for the user who currently uses the client terminal among the restriction information which is downloaded from the server and which is registered in the printer driver data area of the client terminal. Then, the printer driver is started up in the situation in which the function is restricted in accordance with the restriction information. Specifically, by displaying the print setting window in which the function is restricted in accordance with the restriction information for the user who currently uses the client terminal, the setting operation for setting the print condition is received. Therefore, by registering the restriction information relating to the setting of the print condition for each user in the printer driver data area of the server, it is possible to carry out the function restriction according to the user who uses the client terminal when the setting of the print condition is received by the client terminal.

In this embodiment, the server fetches the restriction information relating to the setting of the print condition for each user and registers the fetched restriction information in the printer driver data area of the server. Then, the server transmits the printer driver program stored in the server and the restriction information registered in the printer driver data area to the client terminal. In case that the transmitted printer driver program is executed by the client terminal, the printer driver program is started up in the situation in which the print condition which can be set is restricted in accordance with the restriction information for the current user among the restriction information which is transmitted from the server and which is registered in the printer driver data area of the client terminal.

In this embodiment, the client terminal executes the printer driver program which is downloaded from the server. The printer driver program is started up in the situation in which the function is restricted in accordance with the restriction information for the user who currently uses the client terminal among the restriction information which is downloaded from the server and is registered.

In this embodiment, the server program causes the server to fetch the restriction information and register the fetched restriction information in the printer driver data area.

In this embodiment, the client program causes the client terminal to start up the printer driver program in the situation in which the print condition which can be set is restricted in accordance with the restriction information for the current user.

In this embodiment, in case that the printer driver program is executed by the server, the printer driver program causes the server to fetch the restriction information relating to the setting of the print condition for each user and to register the fetched restriction information in the printer driver data area. In case that the printer driver program is executed by the client terminal which is the download destination, the printer driver program is started up in the situation in which the print condition which can be set is restricted in accordance with the restriction information for the user who currently uses the client terminal.

According to the print system, the server, the client terminal and the non-transitory computer-readable recording medium, it is possible to carry out the function restriction which is different for each user without using a special tool in the printer driver provided from the server to the client terminal.

What is claimed is:

1. A server, comprising:
a first storing unit in which a printer driver program is stored;
a second storing unit in which a printer driver data area is provided;
a restriction information registering unit configured to fetch restriction information relating to a setting of a print condition for each user and to register the restriction information in the printer driver data area; and
a distribution unit configured to download the printer driver program and the restriction information registered in the printer driver data area to a client terminal, and to register the restriction information in a printer driver data area of the client terminal,
wherein in case that the printer driver program is executed by the client terminal, the printer driver program causes the client terminal to have a print condition setting function for obtaining identification information of a user who currently uses the client terminal, obtaining the restriction information for the user from the printer driver data area of the client terminal, preparing a print setting window in which the print condition which can be set is restricted in accordance with the obtained restriction information and displaying the print setting window on a display unit of the client terminal.

2. A server, comprising:
a first storing unit in which a printer driver program is stored;
a second storing unit in which a printer driver data area for registering restriction information relating to a setting of a print condition for each user is provided; and
a distribution unit configured to download the printer driver program and the restriction information registered in the printer driver data area to a client terminal, and to register the restriction information in a printer driver data area of the client terminal,
wherein in case that the printer driver program is executed by the server, the printer driver program causes the server to have a restriction information registering function for fetching the restriction information relating to the setting of the print condition for each user and registering the fetched restriction information in the printer driver data area of the server, and
in case that the printer driver program is executed by the client terminal, the printer driver program causes the client terminal to have a print condition setting function for obtaining identification information of a user who currently uses the client terminal, obtaining the restriction information for the user from the printer driver data area of the client terminal, preparing a print setting window in which the print condition which can be set is restricted in accordance with the obtained restriction information and displaying the print setting window on a display unit of the client terminal.

3. The server of claim 2, wherein in case that the printer driver program is executed by the client terminal, the restriction information registering function is inactive.

4. The server of claim 1, wherein the distribution unit downloads the printer driver program and the restriction information to the client terminal by using a Point and Print.

5. The server of claim 2, wherein the distribution unit downloads the printer driver program and the restriction information to the client terminal by using a Point and Print.

6. A non-transitory computer-readable recording medium in which a printer driver program is stored, wherein the printer driver program is downloaded to a client terminal from a server having a printer driver data area in which restriction information relating to a setting of a print condition for each user is registered,
wherein in case that the printer driver program is executed by the client terminal in which the restriction information downloaded from the server is registered in a printer driver data area of the client terminal, the printer driver program causes the client terminal to have a print condition setting function for obtaining identification information of a user who currently uses the client terminal, obtaining the restriction information for the user from the printer driver data area of the client terminal, preparing a print setting window in which the print condition which can be set is restricted in accordance with the obtained restriction information and displaying the print setting window on a display unit of the client terminal.

7. A non-transitory computer-readable recording medium in which a printer driver program is stored, wherein the printer driver program is downloaded to a client terminal from a server having a printer driver data area in which restriction information relating to a setting of a print condition for each user is registered,
wherein in case that the printer driver program is executed by the server, the printer driver program causes the server to have a restriction information registering function for fetching the restriction information relating to the setting of the print condition for each user and registering the fetched restriction information in the printer driver data area of the server, and
in case that the printer driver program is executed by the client terminal in which the restriction information downloaded from the server is registered in a printer driver data area of the client terminal, the printer driver program causes the client terminal to have a print condition setting function for obtaining identification information of a user who currently uses the client terminal, obtaining the restriction information for the user from the printer driver data area of the client terminal, preparing a print setting window in which the print condition which can be set is restricted in accordance with the obtained restriction information and displaying the print setting window on a display unit of the client terminal.

8. The non-transitory computer-readable recording medium of claim 7, wherein incase that the printer driver program is executed by the client terminal, the restriction information registering function is inactive.

9. The non-transitory computer-readable recording medium of claim 6, wherein the printer driver program and the restriction information are downloaded from the server to the client terminal by using a Point and Print.

10. The non-transitory computer-readable recording medium of claim 7, wherein the printer driver program and the restriction information are downloaded from the server to the client terminal by using a Point and Print.

11. A client terminal, comprising:
a driver obtaining unit configured to obtain a printer driver program and restriction information relating to a setting of a print condition for each user from a server, the restriction information being stored in a printer driver data area of the server;
a third storing unit in which the printer driver program obtained by the driver obtaining unit is stored;
a fourth storing unit in which a printer driver data area for registering the restriction information obtained by the driver obtaining unit is provided; and
an execution unit configured to execute the printer driver program stored in the third storing unit,
wherein the printer driver program causes the client terminal to have a print condition setting function for obtaining identification information of a user who currently uses the client terminal, obtaining the restriction information for the user from the printer driver data area of the client terminal, preparing a print setting window in which the print condition which can be set is restricted in accordance with the obtained restriction information and displaying the print setting window on a display unit of the client terminal.

12. A client terminal, comprising:
a driver obtaining unit configured to obtain a printer driver program and restriction information relating to a setting of a print condition for each user from a server, the restriction information being stored in a printer driver data area of the server;
a third storing unit in which the printer driver program obtained by the driver obtaining unit is stored;
a fourth storing unit in which a printer driver data area for registering the restriction information obtained by the driver obtaining unit is provided; and
an execution unit configured to execute the printer driver program stored in the third storing unit,
wherein in case that the printer driver program is executed by the server, the printer driver program causes the server to have a print condition registering function for fetching the restriction information relating to the setting of the print condition for each user and registering the fetched restriction information in the printer driver data area of the server, and
in case that the printer driver program is executed by the client terminal, the printer driver program causes the client terminal to have a restriction information setting function for obtaining identification information of a user who currently uses the client terminal, obtaining the restriction information for the user from the printer driver data area of the client terminal, preparing a print setting window in which the print condition which can be set is restricted in accordance with the obtained restriction information and displaying the print setting window on a display unit of the client terminal.

13. The client terminal of claim 12, wherein in case that the printer driver program is executed by the client terminal, the restriction information registering function is inactive.

14. The client terminal of claim 11, wherein the printer driver program and the restriction information are downloaded from the server to the client terminal by using a Point and Print.

15. The client terminal of claim 12, wherein the printer driver program and the restriction information are downloaded from the server to the client terminal by using a Point and Print.

16. A print system, comprising:
a server and at least one client terminal,
wherein the server comprises:
a first storing unit in which a printer driver program is stored;
a second storing unit in which a printer driver data area is provided;
a restriction information registering unit configured to fetch restriction information relating to a setting of a print condition for each user and to register the restriction information in the printer driver data area; and
a distribution unit configured to download the printer driver program and the restriction information registered in the printer driver data area to the client terminal, and to register the restriction information in a printer driver data area of the client terminal,
wherein the client terminal comprises:
a third storing unit in which the printer driver program downloaded from the server is stored;
a fourth storing unit in which the printer driver data area for registering the restriction information downloaded from the server to the client terminal is provided; and
an execution unit configured to execute the printer driver program stored in the third storing unit, and
wherein in case that the printer driver program is executed by the client terminal, the printer driver program causes the client terminal to have a print condition setting function for obtaining identification information of a user who currently uses the client terminal, obtaining the restriction information for the user from the printer driver data area of the client terminal, preparing a print setting window in which the print condition which can be set is restricted in accordance with the obtained restriction information and displaying the print setting window on a display unit of the client terminal.

17. A print system, comprising:
a server and at least one client terminal,
wherein the server comprises:
a first storing unit in which a printer driver program is stored;
a second storing unit in which a printer driver data area for registering restriction information relating to a setting of a print condition for each user is provided; and
a distribution unit configured to download the printer driver program and the restriction information registered in the printer driver data area to the client terminal, and to register the restriction information in a printer driver data area of the client terminal,
wherein the client terminal comprises:
a third storing unit in which the printer driver program downloaded from the server is stored;
a fourth storing unit in which the printer driver data area for registering the restriction information downloaded from the server to the client terminal is provided; and
an execution unit configured to execute the printer driver program stored in the third storing unit,
wherein in case that the printer driver program is executed by the server, the printer driver program causes the server to have a restriction information registering function for fetching the restriction information relating to the setting of the print condition for each user and registering the fetched restriction information in the printer driver data area of the server, and
wherein in case that the printer driver program is executed by the client terminal, the printer driver program causes the client terminal to have a print condition setting function for obtaining identification information of a user who currently uses the client terminal, obtaining the restriction information for the user from the printer driver data area of the client terminal, preparing a print setting window in which the print condition which can be set is restricted in accordance with the obtained restriction information and displaying the print setting window on a display unit of the client terminal.

18. The print system of claim 17, wherein in case that the printer driver program is executed by the client terminal, the restriction information registering function is inactive.

19. The print system of claim 16, wherein the printer driver program and the restriction information are downloaded from the server to the client terminal by using a Point and Print.

20. The print system of claim 17, wherein the printer driver program and the restriction information are downloaded from the server to the client terminal by using a Point and Print.

21. A print system, comprising:
a server and at least one client terminal,
wherein the server comprises:
a first storing unit in which a printer driver program is stored;
a second storing unit in which a printer driver data area is provided;
a restriction information registering unit configured to fetch restriction information relating to a setting of a print condition for each user and to register the restriction information in the printer driver data area; and
a transmission unit configured to transmit the restriction information registered in the printer driver data area and the printer driver program stored in the first storing unit to the client terminal in case that the server receives a request to download the printer driver program from the client terminal, and
wherein the client terminal comprises:
a request transmission unit configured to transmit the request to download the printer driver program to the server;
a reception unit configured to receive the restriction information and the printer driver program from the server;
a third storing unit configured to store the printer driver program received by the reception unit;
a fourth storing unit in which a printer driver data area for registering the restriction information received by the reception unit is provided;
a user information obtaining unit configured to obtain identification information of a user who currently uses the client terminal; and
a function restriction unit configured to start up the printer driver program stored in the third storing unit, in a situation in which the print condition which can be set is restricted in accordance with the restriction information for the user indicated in the identification information obtained by the user information obtaining unit among the restriction information stored in the fourth storing unit.

22. The print system of claim 21, wherein the printer driver program and the restriction information are transmitted from the server to the client terminal by using a Point and Print.

23. A server, comprising:
a first storing unit in which a printer driver program is stored;
a second storing unit in which a printer driver data area is provided;
a restriction information registering unit configured to fetch restriction information relating to a setting of a print condition for each user and to register the restriction information in the printer driver data area; and
a transmission unit configured to transmit the restriction information registered in the printer driver data area and the printer driver program stored in the first storing unit to a client terminal in case that the server receives a request to download the printer driver program from the client terminal,
wherein in case that the printer driver program is executed by the client terminal, the printer driver program is started up in a situation in which the print condition which can be set is restricted in accordance with the restriction information for a user who currently uses the client terminal among the restriction information transmitted from the server.

24. The server of claim 23, wherein the printer driver program and the restriction information are transmitted from the server to the client terminal by using a Point and Print.

25. A client terminal, comprising:
a request transmission unit configured to transmit a request to download a printer driver program to a server, the server comprising: a first storing unit in which the printer driver program is stored; a second storing unit in which a printer driver data area is provided; a restriction information registering unit configured to fetch restriction information relating to a setting of a print condition for each user and to register the restriction information in the printer driver data area; and a transmission unit configured to transmit the restriction information registered in the printer driver data area and the printer driver program stored in the first storing unit to the client terminal in case that the server receives a request to download the printer driver program from the client terminal;
a reception unit configured to receive the restriction information and the printer driver program from the server;
a third storing unit configured to store the printer driver program received by the reception unit;
a fourth storing unit in which a printer driver data area for registering the restriction information received by the reception unit is provided;
a user information obtaining unit configured to obtain identification information of a user who currently uses the client terminal; and
a function restriction unit configured to start up the printer driver program stored in the third storing unit, in a situation in which the print condition which can be set is restricted in accordance with the restriction information for the user indicated in the identification information obtained by the user information obtaining unit among the restriction information stored in the fourth storing unit.

26. The client terminal of claim 25, wherein the printer driver program and the restriction information are transmitted from the server to the client terminal by using a Point and Print.

27. A non-transitory computer-readable recording medium in which a server program is stored, wherein the server program causes a server to function as a restriction information registering unit which fetches restriction information relating to a setting of a print condition for each user and registers the fetched restriction information in a printer driver data area,
wherein the server comprises:
a first storing unit in which a printer driver program is stored;
a second storing unit in which the printer driver data area for registering the restriction information is provided; and
a transmission unit configured to transmit the restriction information registered in the printer driver data area and the printer driver program stored in the first storing unit to a client terminal in case that the server receives a request to download the printer driver program from the client terminal.

28. The non-transitory computer-readable recording medium of claim 27, wherein in case that the printer driver program is executed by the client terminal, the printer driver program is started up in a situation in which the print condition which can be set is restricted in accordance with the restriction information for a user who currently uses the client terminal among the restriction information transmitted from the server.

29. The non-transitory computer-readable recording medium of claim 27, wherein the printer driver program and the restriction information are transmitted from the server to the client terminal by using a Point and Print.

30. Anon-transitory computer-readable recording medium in which a client program is stored, wherein the client program causes a client terminal to execute:
transmitting a request to download a printer driver program to a server, wherein in the server, the printer driver program is stored and restriction information relating to a setting of a print condition for each user is registered in a printer driver data area, and in case that the server receives the request to download the printer driver program from the client terminal, the server transmits the restriction information registered in the printer driver data area and the printer driver program to the client terminal;
receiving the restriction information and the printer driver program from the server;
storing the received restriction information and the received printer driver program in a storing unit; and
starting up the printer driver program in a situation in which the print condition which can be set is restricted in accordance with the restriction information for a user who currently uses the client terminal among the restriction information stored in the storing unit.

31. The non-transitory computer-readable recording medium of claim 30, wherein the printer driver program and the restriction information are transmitted from the server to the client terminal by using a Point and Print.

32. A non-transitory computer-readable recording medium in which a printer driver program is stored, wherein the printer driver program is transmitted from a server to a client terminal according to a request to download the printer driver program, which is transmitted from the client terminal,
wherein in case that the printer driver program is executed by the server, the printer driver program causes the server to have a restriction information registering function for fetching restriction information relating to a setting of a print condition for each user and registering the fetched restriction information in a printer driver data area of the server, and
wherein in case that the printer driver program is executed by the client terminal to which the printer driver program and the restriction information are downloaded from the server, the printer driver program is started up in a situation in which the print condition which can be set is restricted in accordance with the restriction information for a user who currently uses the client terminal among the downloaded restriction information.

33. The non-transitory computer-readable recording medium of claim 32, wherein the printer driver program and the restriction information are transmitted from the server to the client terminal by using a Point and Print.
